(19) United States
(12) Patent Application Publication
(10) Pub. No.: US 2007/0230008 A1
(43) Pub. Date: Oct. 4, 2007

(54) Reproducing circuit and a magnetic disk apparatus using same

(75) Inventors: Toshio Shinomiya, Ome (JP); Yoichiro Kobayashi, Ome (JP); Yuki Nomura, Ome (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 11/698,164

(22) Filed: Jan. 26, 2007

(30) Foreign Application Priority Data
Mar. 30, 2006 (JP) 2006-092778

(51) Int. Cl. G11B 5/03

(52) U.S. Cl. 360/66

(57) ABSTRACT

A reproducing circuit for magnetic disks wherein a MR head bias voltage does not exceed the specified value during any malfunction of the power supply voltage including the cases of power supply ON/OFF, and the central voltage of the MR head is controlled to the ground. The reproducing circuit for magnetic disk apparatus is composed of a MR head, a bias circuit that provides bias voltage specified relative to the MR head, an amplifying circuit for amplifying the output signals of the MR head, a power supply voltage monitor circuit that monitors the changes in the power supply voltage, and a control circuit that is controlled by the power supply voltage monitor circuit. MR bias voltage does not exceed the specified value during any malfunction of the power supply voltage including the cases of power supply ON/OFF, and the central voltage of the MR head is controlled to the ground such that the MR head is protected.

### CLAIM OF PRIORITY

The present application claims priority from Japanese application JP 2006-092778 filed on Mar. 30, 2006, the content of which is hereby incorporated by reference into this application.

### FIELD OF THE INVENTION

This invention relates to a reproducing circuit and a magnetic disk apparatus using the reproducing circuit. In particular, it relates to a reproducing circuit when it is effectively used in magnetic disk apparatus using a magnetoresistive head (hereinafter referred to as MR head).

### BACKGROUND OF THE INVENTION

Japanese Patent JP-A No. 2002-358604 is a reference describing a current bias circuit of the magnetic signal detecting head that is used in the magnetic recording apparatus. FIG. 1 of the same reference shows an example of a circuit for preventing a large current from running temporarily into the MR head when switching the head or when switching the bias current.

### SUMMARY OF THE INVENTION

The preamp used in the magnetic disk apparatus is composed of multiple operation modes such as a write mode for writing-in the data in a recording medium, a read mode for reading-out the data from the recording medium, and a sleep mode for stopping operation wherein switching between the operation modes is performed at a high speed. As a reproducing circuit, this invention includes the MR head bias voltage and switching operations besides those mentioned above. With higher density of recording media, higher density of MR head media and higher transfer speed of the apparatus, it is requested for the preamp to have a shorter transition time among the various operation modes. Also, in response to the fact that the breakdown resistance decreased in spite of achievement of higher sensitivity of the head medium in the reproducing circuit, it is important to further pay attention to overvoltage of the MR head bias voltage which easily occurs when switching operation modes. As measures, for example, both prevention of overvoltage of the MR head bias voltage and higher speed switching operations are achieved by temporarily performing high-speed recovery of the dummy head resistance equipped in the interior when switching the mode to be ready for shifting the next operation mode. Also, a technique shown in Japanese Patent JP-A No. 2002-358604 may be one of the solutions for the requirements. Therefore, a variety of measures have been taken for the mode switching as instructed from the apparatus. However, a reduction in breakdown resistance of the MR head increases the possibility of inducing deterioration of characteristics and breakdown even though the overvoltage of the MR head bias voltage exists even for a very short time. Namely, when changing the power supply voltage exceeding the specified power supply voltage including the case when turning off the power supply in the case when recovering from the off state of the power supply other than the expected mode switching, it is important to control the MR head central voltage to the ground in order to prevent overvoltage of the MR head bias voltage and to prevent contact breakdown with the recording media.

Prior to this application, the inventors investigated prevention of overvoltage of the MR head bias voltage and control over grounding the central voltage of the MR head when changing the power supply voltage exceeding the specified power supply voltage including the case when turning off the power supply when recovering from the off state of the power supply. FIG. 14 shows a reproducing circuit of the most common magnetic disk apparatus used for our investigation. A reproducing circuit is composed of a MR head 100, a bias circuit 200 providing the MR head a bias voltage VMR specified by the Vref, an initial stage amplifier 400 and a later stage amplifier (not shown) for amplifying the output signals of the MR head. The monitor circuit 210 monitors the bias voltage VMR to output a voltage Vdif depending upon the bias voltage VMR. FIG. 15 shows a circuit diagram of a monitor circuit 210. The input voltage Vbhp and Vbhn of the monitor circuit 210 are equivalent to a positive pole voltage Vmp and a negative pole voltage Vmn of the respective MR head 100. The amplifier AP1 receives the input voltage Vbhp to drive the transistor MN4 in order to control the source voltage of the transistor MN5 to be equal to the input voltage Vbhp. Similarly, the amplifier AP2 receives the input voltage Vbhn to drive the transistor MN6 in order to control the source voltage of the transistor MP3 to be equal to the input voltage Vbhn. As a result, a voltage that is equal to the bias voltage VMR is applied at both ends of the resistor R1 and a voltage obtained by multiplying the bias voltage VMR by a resistance ratio R2/R1 is output at both ends of the resistor R2 receiving the current Id. Namely, the output voltage Vdif of the monitor circuit 210 outputs a voltage depending upon the bias voltage VMR relative to the power supply VCC. The amplifier 220 compares the output voltage Vdif of the monitor circuit 210 with the standard voltage Vref for specifying the bias voltage VMR, in order to control the bias voltage VMR to the specified value. Also, the amplifier 230 compares the central point voltage Vcom of the pair of resistors Rg that are connected in parallel to the MR head 100 relative to the ground in order to control the center voltage of the MR head 100 to be grounded. The resistor Rd is a dummy head resistor installed inside. When providing a bias voltage VMR to the MR head 100, the bias voltage VMR is controlled by turning on switches S11 to S15 and by turning off switches S16 and S17. When the dummy head resistor Rd is selected or when it is shifted temporarily to the dummy head resistor Rd while switching the mode, the switches S11 through S15 are turned off and the switches S16 and S17 and S21 through S25 are turned on so that the specified value of the bias voltage is provided to be controlled relative to the bias voltage Vd of the dummy head resistor Rd. Since the dummy head resistor Rd is a sufficiently higher value when compared to the resistance value of the MR head 100, the current running through the resistor Rd becomes smaller when the dummy head resistor Rd is selected when compared to the current running through the MR head 100 when the bias voltage VMR is applied to the MR head 100. As a result, a voltage drop due to the resistor Rm becomes less and the internal voltages V1 and V3 decrease, while internal voltages V2 and V4 increase. Thus, when switched from the dummy head resistor Rd to the MR head 100, the status when the bias voltage that is always less than the specified value is applied is controlled to the specified value so that the occurrence of overvoltage of the bias voltage can be prevented.

As measures for preventing overvoltage of the MR head bias voltage VMR and controlling grounding of the MR had central voltage when changing the power supply voltage beyond the specified power supply voltage including the case of turning off the power supply and the case of restoring from the power supply off state, transition to the dummy head resistor Rd was investigated. Based on the investigational circuit shown in FIG. 14, as operations when changing the power supply voltage before executing the dummy head transition measures, when the power supply VEE shifts from the steady state to a zero bias state and then restores the steady state, the responses are shown in FIG. 16. Generally, the preamp has a function of reporting malfunctions detected when the power supply voltage becomes lower than the specified voltage Vf set below the rated power supply voltage. When the power supply VEE decreases beyond the specified voltage Vf and reaches the power supply voltage Vx where the circuit is not operated normally, for example, the transistor NM1 and the current supply CS2 in FIG. 14 are not operated, but the internal voltages V2 and V4 are elevated due to increase by the power supply VEE, causing an elevation of the MR head central voltage. Also, in the monitor circuit 210, the amplifier AP2 in FIG. 15 cannot control the lower end of the resistor R1 to push the lower end of the resistor R1 as well as a reduction in the power supply VEE, causing generation of an increase in the output voltage Vdif. As a result, the amplifier 220 increases the bias voltage VMR and a bias voltage greater than the specified value is applied to the MR head 100.

Using the malfunction signals detected when the power supply VEE becomes lower than the specified voltage Vf, transition to the dummy resistor Rd was investigated. The responses in this case are shown in FIG. 17. If the power supply VEE becomes lower than the specified voltage Vf when being transitioned to the dummy head resistor Rd using the detection signals PLF being inverted to L→H, the bias voltage VMR of the MR head 100 is blocked without generating overvoltage, and the ground of the MR head central voltage can be maintained by turning on the switches S16 and S17. However, the internal responses when the power supply VEE reaches the power supply voltage Vx even though the dummy head resistor Rd is selected are unchanged from those before executing the measures for dummy head transition in FIG. 16, and a bias voltage greater than the specified value is applied to the dummy head resistor Rd. That is, if the power supply VEE becomes below the power supply voltage Vx, there is a possibility that a bias voltage exceeding the specified value is applied to the MR head 100. Although there is a sufficient voltage difference between the specified voltage Vf relative to the power supply VEE and the power supply voltage Vx, there is a possibility that overvoltage may be generated temporarily at the MR head bias voltage VMR during the transition period to the dummy head resistor Rd depending upon the through rate of the variations in the power supply voltage. Also, the similar operations occur in the case of power supply VCC.

Based on the aforementioned investigation, this invention invented a reproducing circuit wherein the MR head bias voltage does not exceed the specified value when changing the power supply voltage including the cases of power supply ON/OFF, and which can protect the MR head by controlling the central voltage of the MR head to the ground.

An example of typical cases of this invention is described below. That is, the reproducing circuit of this invention is composed of a magnetoresistive head, a bias circuit that provides bias voltage specified relative to the magnetoresistive head, an amplifying circuit for amplifying the output signals of the magnetoresistive head, a power supply voltage monitor circuit that monitors the changes in the power supply voltage, and a control circuit that is controlled by the power supply voltage monitor circuit. It is characterized that the bias voltage does not exceed the specified value during any malfunction of the power supply voltage including the cases of power supply ON/OFF, and the central voltage of the magnetoresistive head is controlled to the ground.

Also, the magnetic disk apparatus of this invention is equipped with a magnetoresistive head, a reproducing circuit that is electrically connected to the magnetoresistive head, and a read write channel circuit that is electrically connected to the reproducing circuit.

The reproducing circuit is composed of a bias circuit that provides a bias voltage specified relative to the magnetoresistive head, an amplifying circuit that amplifies the output signals of the magnetoresistive head, a power supply voltage monitor circuit that monitors the changes in the power supply voltage, and a control circuit that is controlled by the power supply voltage monitor circuit. It is characterized that the bias voltage does not exceed the specified value during the malfunctions of the power supply voltage including the cases of power supply ON/OFF, and the central voltage of the magnetoresistive head is controlled to the ground.

This invention provides a reproducing circuit in which MR head bias voltage does not exceed the specified value during the malfunctions of the power supply voltage including the cases of power supply ON/OFF, and the central voltage of the MR head is controlled to the ground, and a magnetic disk apparatus using the reproducing circuit.

### BRIEF DESCRIPTION OF THE DRAWINGS

FIG. 1 is a configuration diagram of a reproducing circuit wherein this invention is applied;

FIG. 2A is a configuration diagram of a MR head bias voltage monitor which is applicable as a monitor circuit shown in FIG. 1;

FIG. 2B is a configuration diagram of a MR head bias voltage monitor which is applicable as a monitor circuit shown in FIG. 1;

FIG. 2C is a configuration diagram of a MR head bias voltage monitor which is applicable as a monitor circuit shown in FIG. 1;

FIG. 3 is an embodiment of the reproducing circuit wherein this invention is applied;

FIG. 4 is a detailed circuit diagram of a power supply voltage dependent current generation circuit sown in FIG. 3;

FIG. 5 is an example of timing diagram when the power supply voltage changes in the reproducing circuit;

FIG. 6 is a configuration diagram of a reproducing circuit wherein this invention is applied in the monitor circuit shown in FIG. 3;

FIG. 7 is a detailed circuit diagram of the monitor circuit shown in FIG. 6;

FIG. 8 is an example of timing diagram when the power supply voltage changes in the reproducing circuit shown in FIG. 6;

FIG. 9 is a configuration diagram describing a dummy head in the reproducing circuit;

FIG. 10 is a timing diagram when the power supply voltage changes in the reproducing circuit shown in FIG. 9;

FIG. 11 is an embodiment of the magnetic disk apparatus having a preamplifier wherein this invention is applied;

FIG. 12 is a key outlined structural diagram of a magnetic disk apparatus shown in FIG. 11;

FIG. 13 is a block diagram showing an embodiment of the preamplifier wherein this invention is applied;

FIG. 14 is a configuration diagram of a common reproducing circuit;

FIG. 15 is a detailed circuit diagram of the monitoring circuit shown in FIG. 14;

FIG. 16 is an example of timing diagram when the power supply voltage changes in the reproducing circuit shown in FIG. 14; and

FIG. 17 is an example of timing diagram when the power supply voltage changes for which measures have been investigated in the reproducing circuit shown in FIG. 14.

### DETAILED DESCRIPTION OF THE PREFERRED EMBODIMENTS

Embodiments of this invention will be explained with reference to the drawings. The circuit elements constituting each block of the embodiment are not particularly limited; however, according to integrated circuit technology such as known CMOS (complementary type MOS transistors), they are formed on a single semiconductor substrate such as a single crystal silicon.

### Embodiment 1

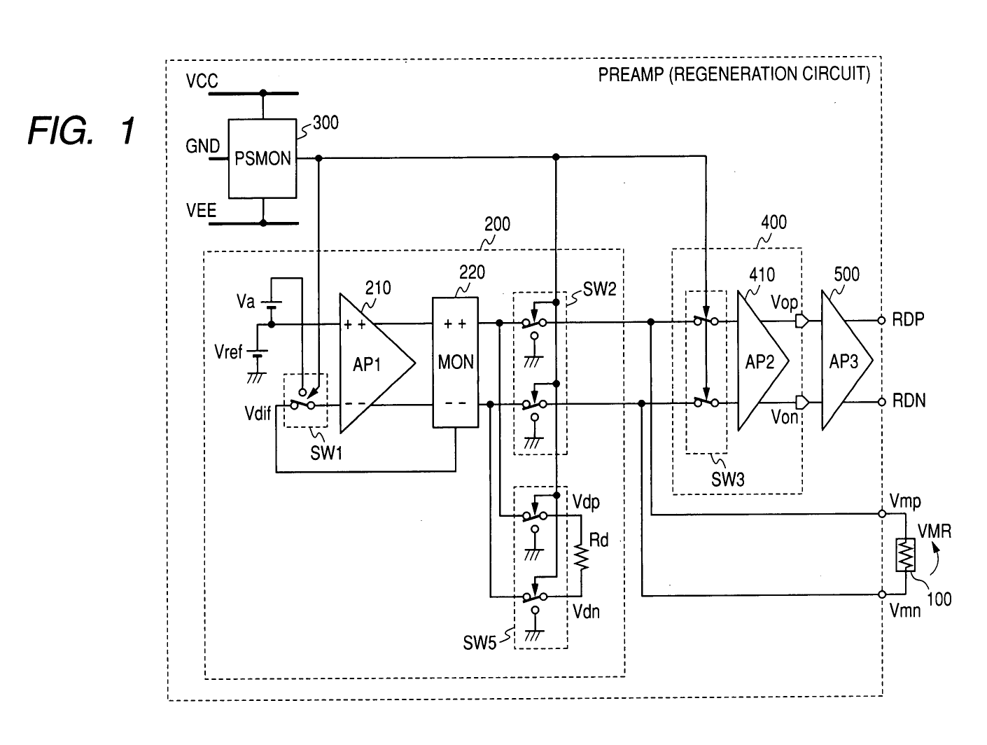

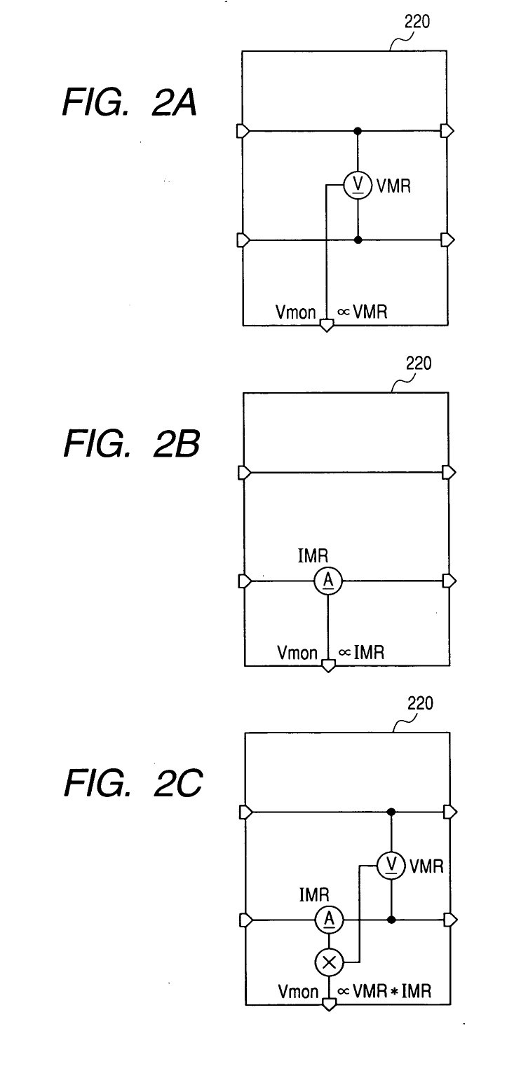

FIG. 1 shows a first embodiment of a reproducing circuit for magnetic disk apparatus wherein this invention is applied. This reproducing circuit is composed of a MR head 100, a bias circuit 200 which provide a bias voltage VMR specified in the ME head by Vref, a power supply voltage monitor circuit 300 for monitoring the power supply voltage variances, and an initial-stage amplifier 400 and a later-stage amplifier 500 that amplify output signals of the MR head. The bias circuit 200, after an amplifier 210 compares the output voltage Vdif of the monitor circuit 220 which monitors the bias status of the MR head 100, with the Vref, controls to the bias voltage VMR specified by the Vref. The monitor circuit 220 monitors one of (a) bias voltage VMR of the MR head 100, (b) bias current IMR running through the MR head 100, and (c) the power generated in the MR head 100 to output a voltage Vdif as shown in FIG. 2 based on the objective of the control of the MR head 100 so that the bias voltage VMR is controlled such that each value is specified by the Vref. In the reproducing circuit shown in FIG. 1, the bias circuit 200 or the initial stage amplifier 400 are controlled using control circuits SW1 through SW4 that are controlled b the power voltage monitor circuit 300 such that the bias voltage VMR does not exceed the specified value during the period of power supply voltage malfunction including power supply ON/OFF and the central voltage of the MR head is controlled to the ground. In particular, it switches the negative input voltage Vdif of the amplifier 210 to a voltage higher by a voltage of Va relative to the Vref using a control circuit SW1 such that the return circuit is controlled in order to output a lower voltage than the bias voltage specified by the Vref. Also, it is also characterized that the bias voltage to the MR head 100 can be blocked by control circuits SW2 to SW3. Moreover, it is also characterized that the bias voltage blocking of the MR head can be transitioned to the dummy head resistance Rd by the control circuit SW5. Examples of the control circuits will be explained in detail below.

### Embodiment 2

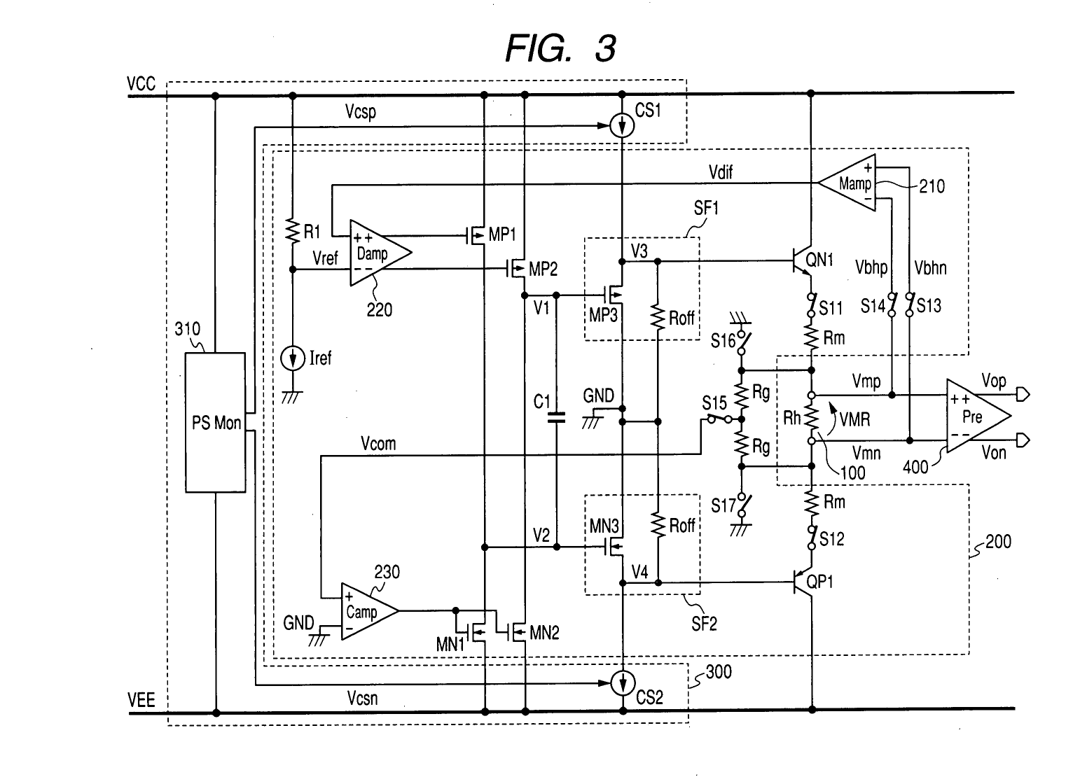

FIG. 3 shows a second embodiment of the reproducing circuit for magnetic disk apparatus wherein this invention is applied. This reproducing circuit is composed of a MR head 100, a bias circuit 200 that provides a bias voltage VMR specified based on the Vref in the MR head, a bias circuit 300 generating a current that depends upon the power supply voltage, an initial stage amplifier 400 and a later stage amplifier (now shown) that amplify the output signals of the MR head.

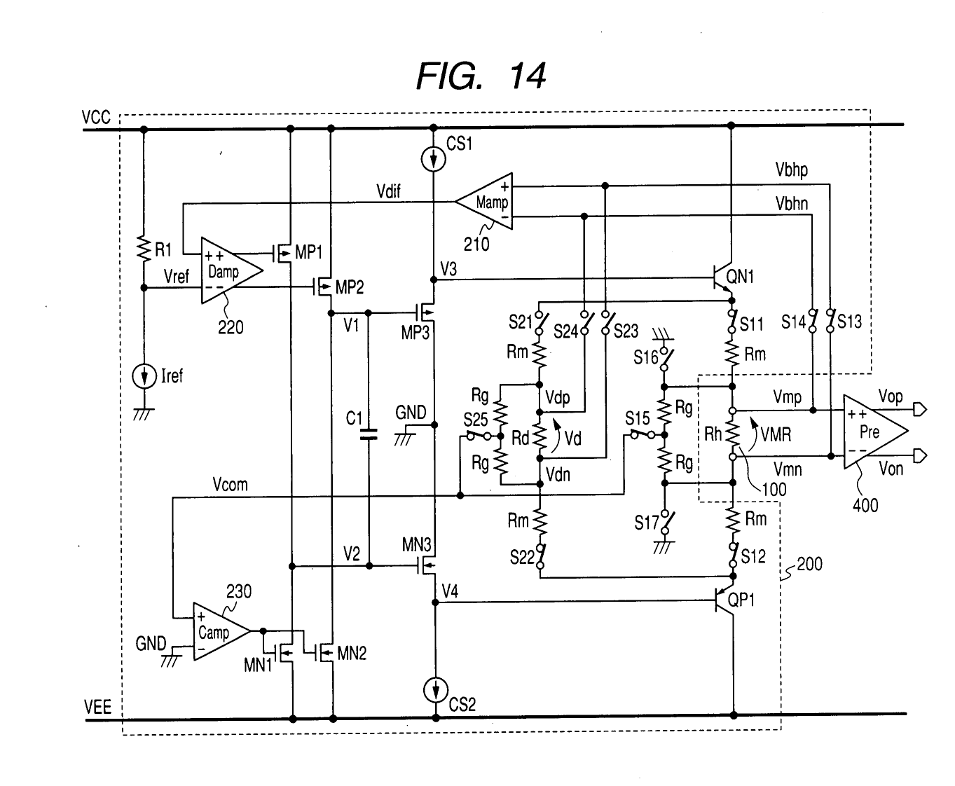

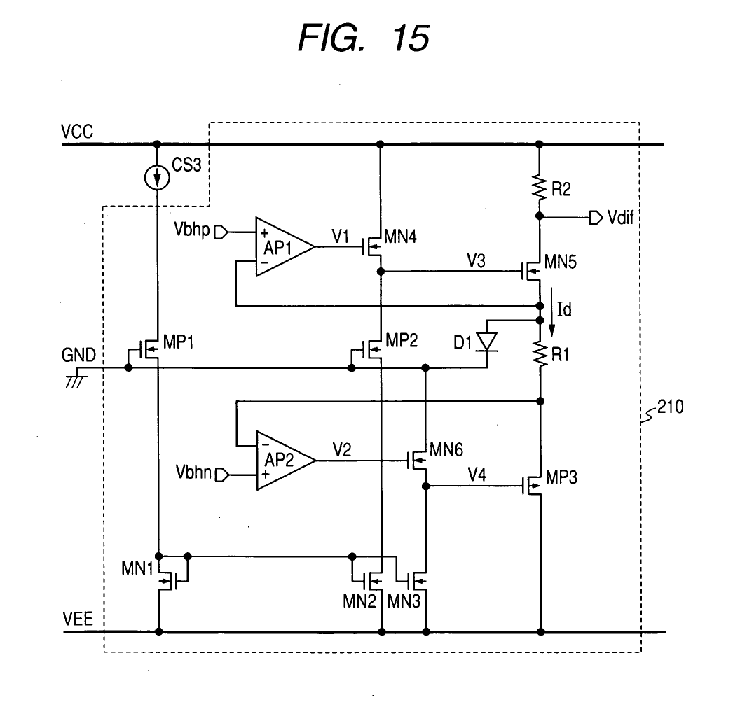

Regarding the control of bias voltage VMR, the constitution and operation are common to those shown in FIG. 14 and FIG. 15 so that their explanations are omitted and only the differences will be explained below.

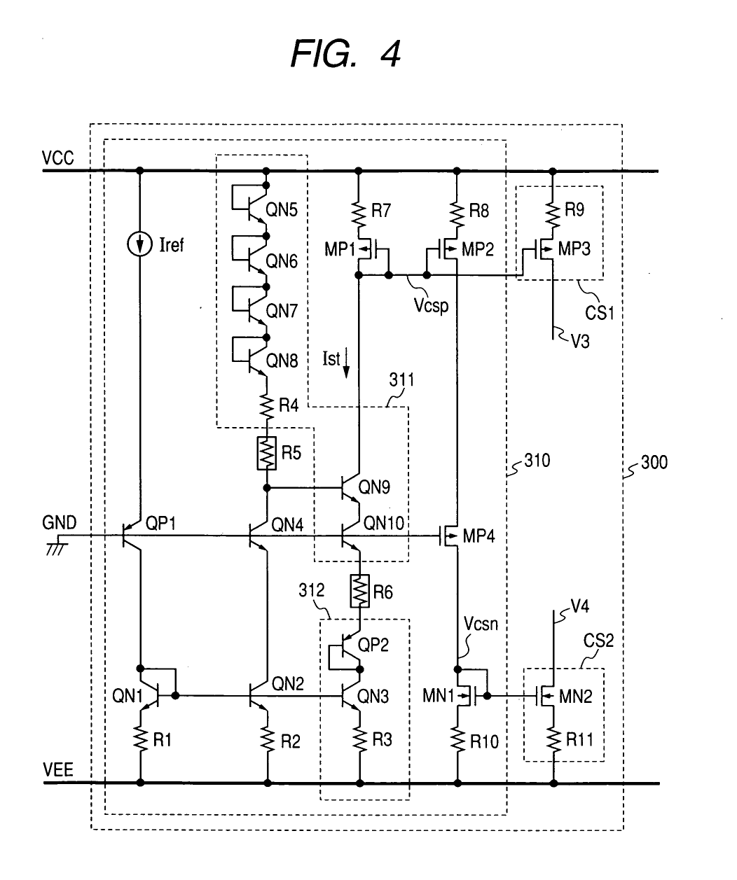

The source followers for transistors MP3 and NM3 have resistances Roff that are connected respectively between the output source terminal and the ground to configure analog switches SF1 and SF2 that are controlled by the power supply voltage dependent current supplies CS1 and CS2. Also, the bias circuit 300 is composed of a power supply voltage monitor circuit 310 shown in FIG. 4 and current mirrors CS1 and CS2 described in FIG. 3. The monitor circuit 310 having dummy circuits 311 and 312 which imitate arbitrary circuits in the reproducing circuit monitors saturation operations of the arbitrary circuits by the current saturation characteristics of the transistor QN10 when the power supply VCC decreases and by those of the transistor QN3 when the power supply VEE decreases, to generate a standard current Ist that shuts down as the voltage of the power supplies VCC and VEE decreases. Those which are copied from the standard current Ist are then supplied as current supplies CS1 and CS2 in FIG. 3. The resistors R5 and R6 added to this dummy circuit may be replaced by diodes, but they are inserted in order to adjust the degree of dependence on power supply voltage. Thus, it is set at a power supply voltage Vs higher than the power supply voltage Vx wherein the arbitrary circuit is no longer operated normally due to a reduction in the power supply voltage to generate the standard current Ist that is shutting down before the occurrence of malfunctioned operation.

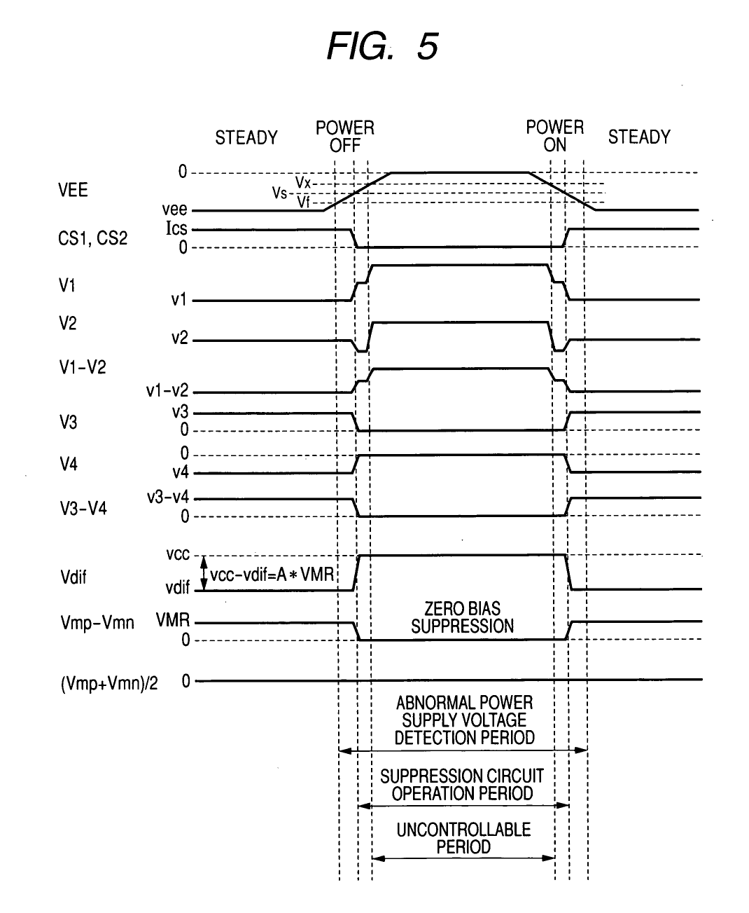

As actions while power supply voltage varies, FIG. 5 shows responses when the power supply VEE transfers from a steady state to a zero bias state and then restores back a steady state. In the case when the power supply VEE exceeds from the steady state beyond the power supply voltage specification range to be turned OFF, the standard current Ist is shut down below the threshold voltage Vs which is setup by the dummy circuit 312 and resistor R6 in FIG. 4 so that the current supplies CS1 and CS2 are turned OFF. In this case, the output source terminals of the transistors MP3 and NM3 become high impedance and the output source voltages V3 and V4 are induced to the ground by the resistor Roff and the differential voltage (V3-V4) changes to zero. Since this operation is not controlled by a digital switch, generation of noises when switching is low, the operation is secured even when the power supply decreases abnormally such that the logical signals become uncertain, and the bias voltage is controlled to a zero bias without exceeding the specified values while inhibiting the changes in the bias voltage VMR. On the other hand, the operation when restoring the steady state from the state when the power supply VEE is turnedOFF, the operation becomes reversed. Asthe powersupply VEE exceeds the threshold value voltage Vs, the analog switches SF1 and SF2 function as source followers so that the controls are transferred to achieve specified values of the bias voltage VMR from the zero bias control, and the ground control at the central voltage of the MR head functions normally without generating overvoltage. Also, this operation is similar for the power supply VCC.

### Embodiment 3

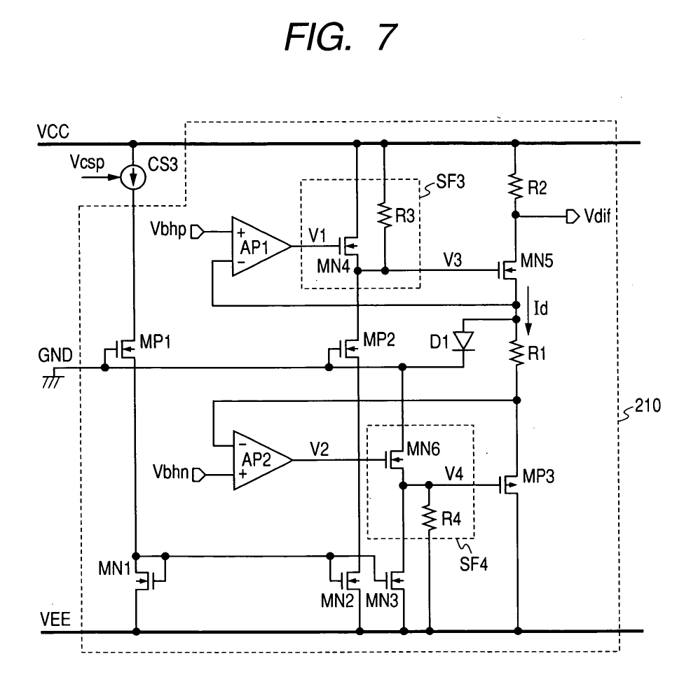

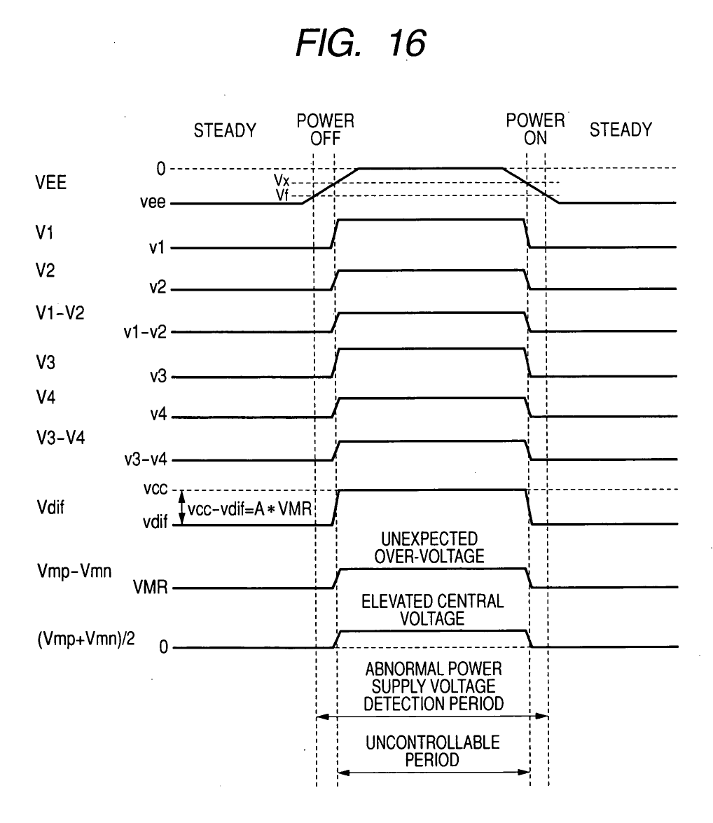

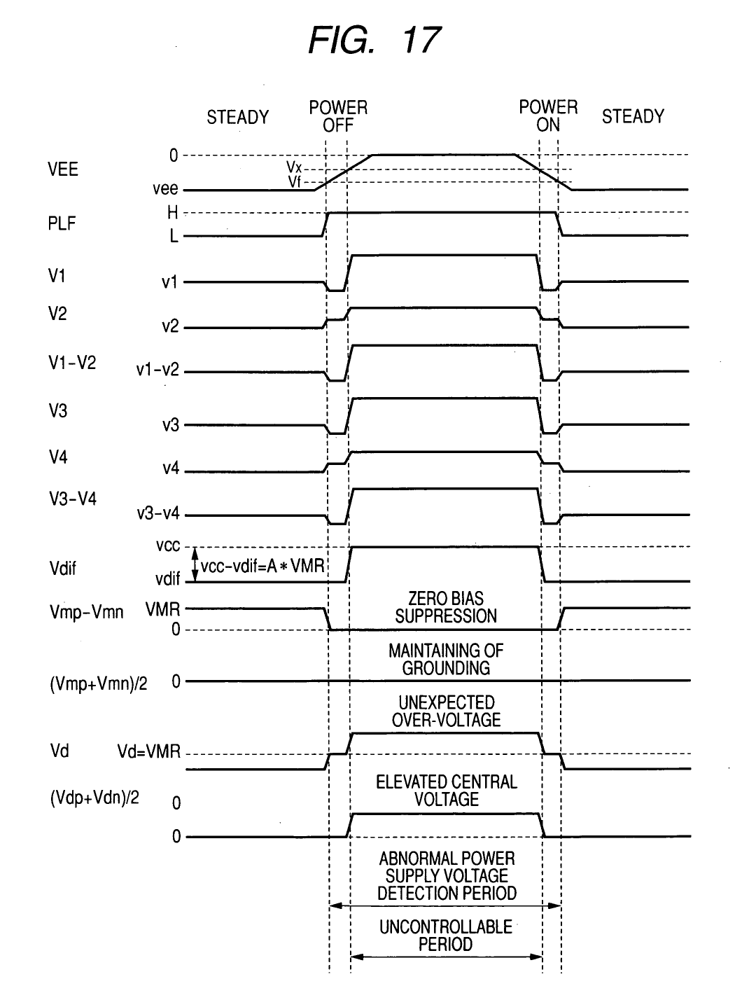

FIG. 16 shows a third embodiment of the reproducing circuit for magnetic disk apparatus wherein the present invention is applied. The circuit configuration is similar to that in the second embodiment in FIG. 3, but the point of difference is that the power supply voltage dependent current CS3 is supplied to the monitor circuit 210. FIG. 7 shows a circuit diagram of the monitor circuit 210. Since FIG. 7 has common configuration and operations as those in the circuit shown in FIG. 15, explanations will be omitted and only the points of difference will be explained.

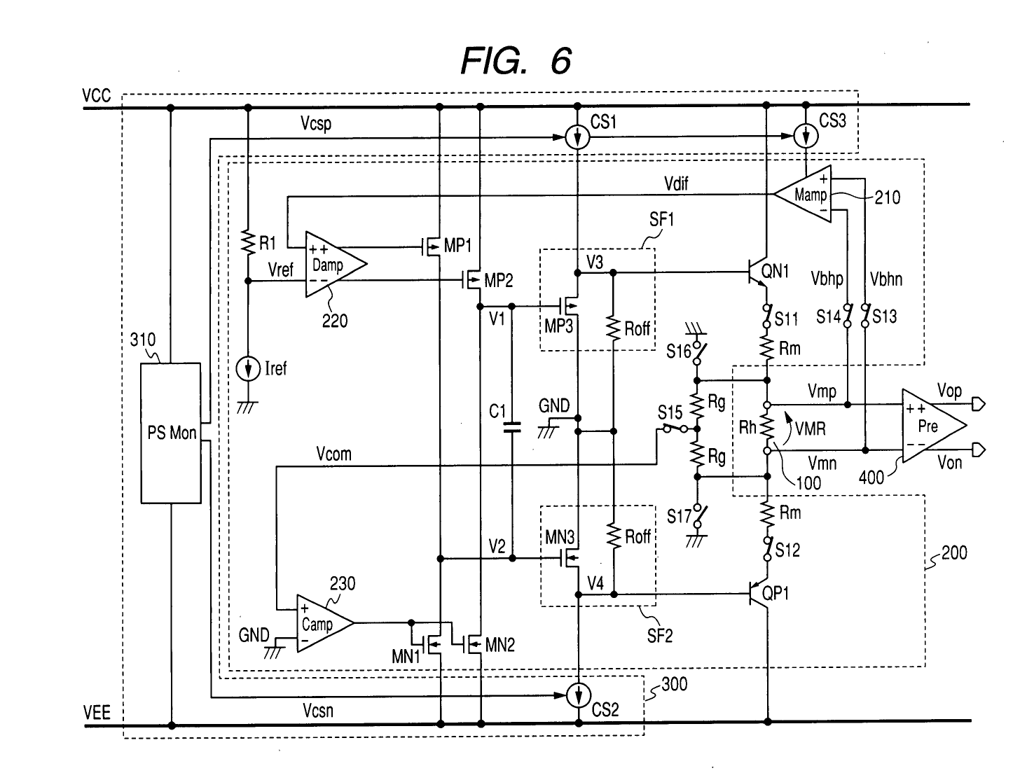

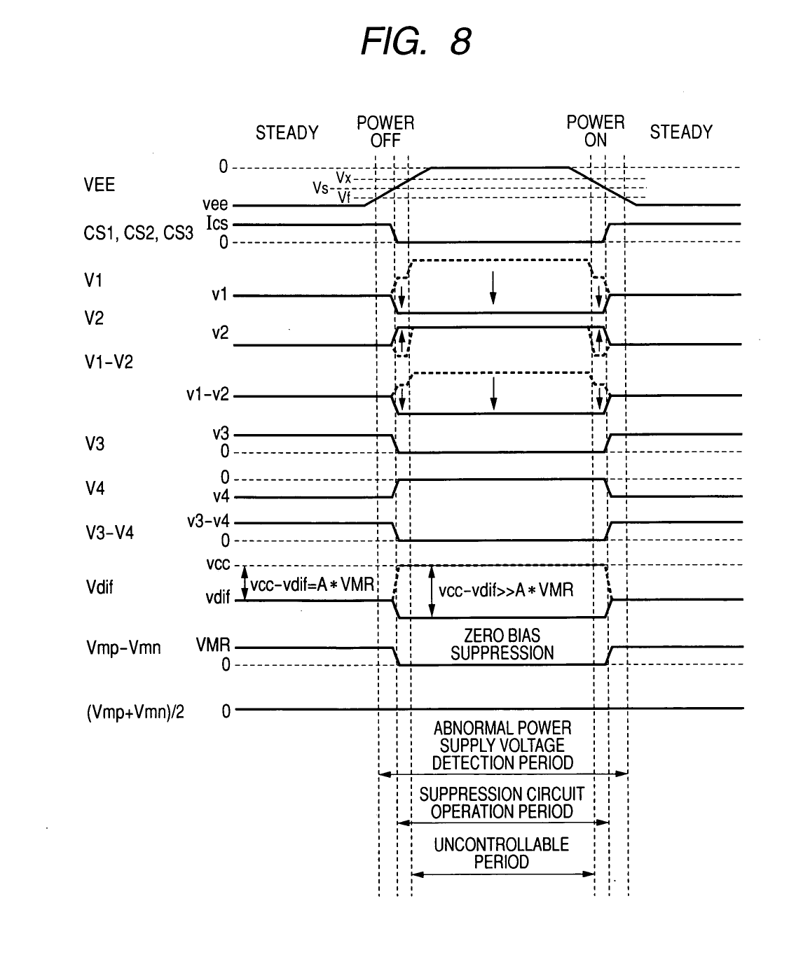

In the second embodiment, since the bias voltage VMR is blocked by the effect of this invention when the power supply voltage decreases as shown in FIG. 5, the output voltage Vdif of the monitor circuit 210 becomes a power supply VCC. Thus, the amplifier 220 in FIG. 3 controls to increase voltage (V1-V2) between the gates of transistors MP3 and MN3 in order to provide the bias voltage VMR a specified value. Since analog switches SF1 and SF2 are still OFF in this state, the bias voltage VMR do not change, but I is not desirable to be at the operation point where overvoltage is applied to the bias voltage VMR as a processing of the return circuit. Therefore, analog switches SF3 and SF4 are used in the monitor circuit 210 in FIG. 7. As operations when the power supply voltage changes in FIG. 6, FIG. 8 shows responses when the power supply VEE changes from the steady state to zero bias and restores a steady state. The analog switches SF3 and SF4 in FIG. 7 operate in the sample principle as for analog switches SF1 and SF2. If the power supply VEE decreases from the threshold value voltage Vs that is setup by the dummy circuit 312 and the resistor R6 in FIG. 4, the current supply CS3 is blocked so that the gate voltage of the transistor MN5 is induced to a power supply VCC and the gate voltage of the transistor MP3 is induced to the power supply VEE. Thus, a voltage greater than the bias voltage VMR is generated at both ends of the resistor R1 to control the output voltage of the monitor circuit 210. As a result, the amplifier 220 in FIG. 6 reduces the inter gate voltage (V1-V2) of the transistors MP3 and MN3 so that the operation point is achieved such that the bias voltage VMR as an internal state of the circuit does not exceed the specified value. In contrast, the operation when the power supply VEE restores the steady state from the off state undergoes in an opposite direction such that as the power supply VEE exceeds the threshold voltage Vs, the control shifts from the zero bias control to the control that the bias voltage VMR shows the specified value. Therefore, the ground control at the MR head central voltage functions normally instead of the occurrence of overvoltage. Also, this operation is the same for the power supply VCC.

### Embodiment 4

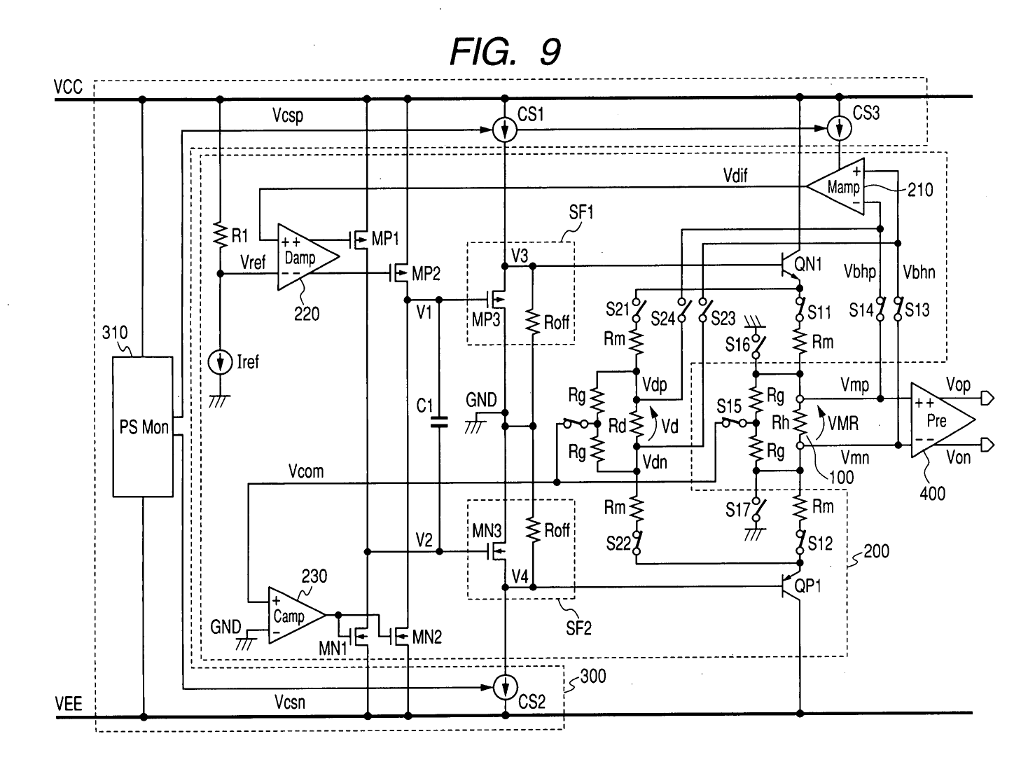

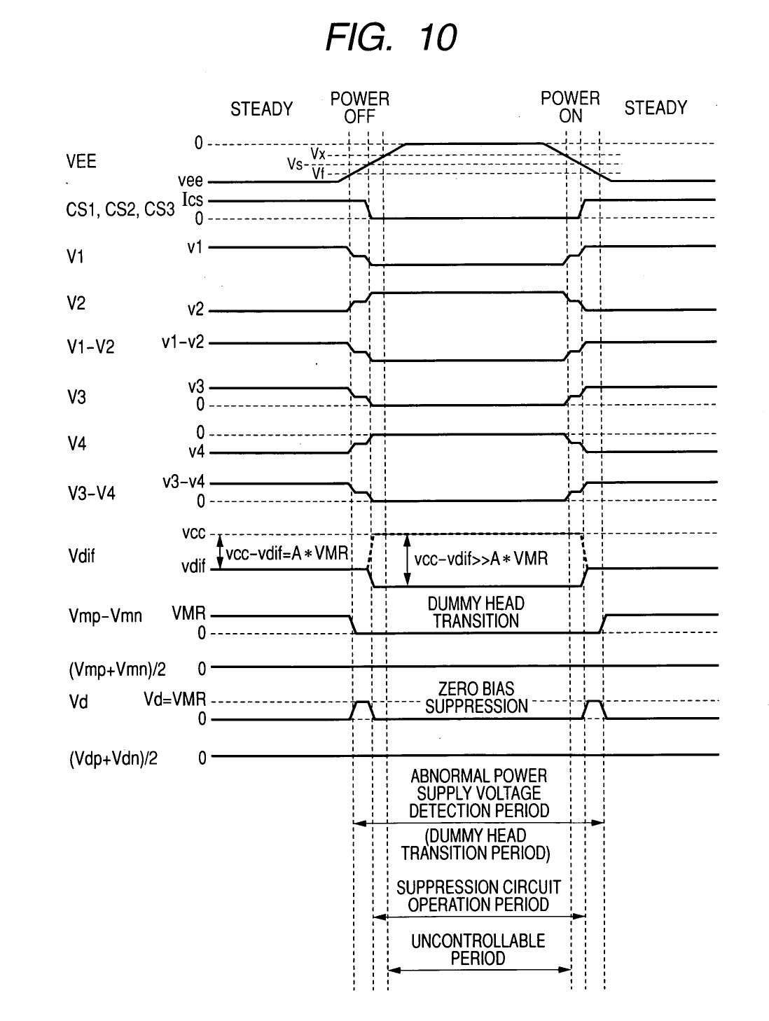

In the fourth embodiment, prevention of overvoltage of the MR head bias voltage by dummy head shifts using the detection signals for an abnormal reduction of power supply voltage as investigated prior to this application and the ground control measures of the MR head central voltage are applied to the second embodiment. It is similar when they are applied to the third embodiment. When they are applied to the third embodiment, the circuit diagram in FIG. 9 will be explained. In the circuit diagram in FIG. 9, elements related to the dummy head resistor Rd which are omitted in the circuit diagram in FIG. 6, but which are shown in FIG. 14 are added. Thus, explanations of control over the bias voltage VMR and the functions of the dummy head resistor Rd and its control operations in FIG. 9 are omitted. As operations when the power supply voltage changes, FIG. 10 shows responses when the power supply VEE shifts from the steady state to a zero bias state and hen restores the steady state. If the power supply VEE turns OFF beyond the specification range of the power supply voltage from the steady state, the malfunction detection signal PLF is inverted to L→H when reaching the specified voltage Vf, transition to the dummy head resistor Rd is executed using this signal. At this point, the MR head bias voltage VMR is blocked and the MR head 100 is grounded by turning on switches S16 and S17. Moreover, when the power supply VEE decreases and reaches to the threshold voltage Vs that is setup by the dummy circuit 312 and the resistor R6 in FIG. 4, the standard current Ist is blocked and the current supplies CS1 to CS3 in FIG. 9 are turned off. As a result, analog switches SF1 and SF2 in FIG. 9 and analog switches SF3 and SG4 in FIG. 7 showing the monitor circuit 210 are turned off, it is controlled to such a state wherein the application of overvoltage to the bias voltage VMR is disabled. By this two-step control for the power supply voltage, even slight noises when analog switches are operated can be always masked by the dummy head transition prior to this, enabling the control with enhanced security. On the other hand, when the power supply VEE restores the steady state from the off state, the reversed operations are performed. Also, this operation is the same for the power supply VCC.

### Embodiment 5

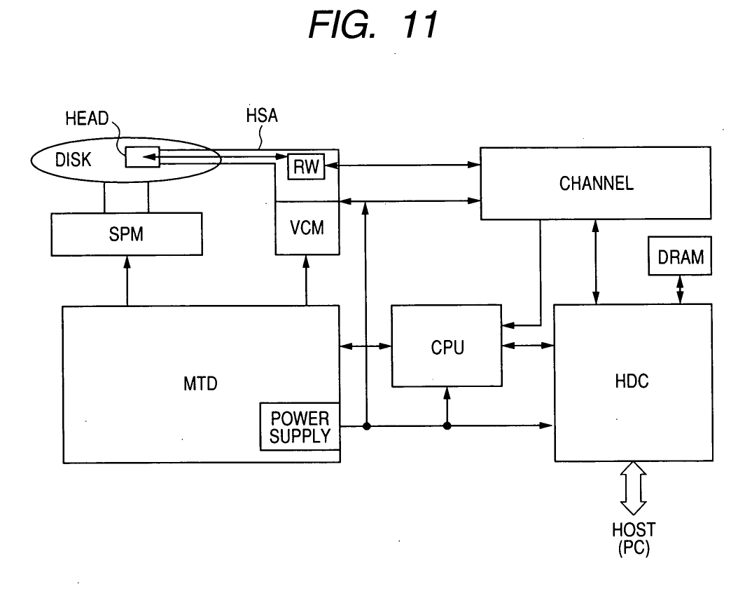

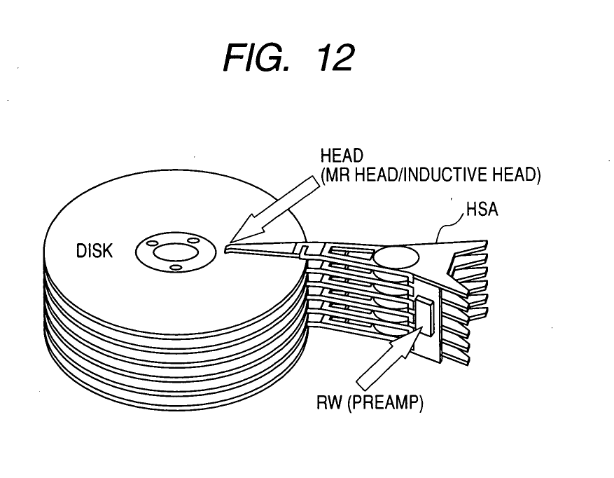

The block diagram of FIG. 11 is one embodiment of the magnetic disk apparatus equipped with a preamp wherein this invention is applied. The preamp (reproducing circuit) RW (Preamp) performs read-out and write-in of data, respectively on a recording media Disk via a composite head HEAD of a MR head and a magnetic (inductive) head (MR Read Head/Inductive write Head). The suspension HAS (Head Stack Assembly) mechanically supports the composite head HEAD as well as it is equipped with wiring providing electrical connections between the suspension HSA and the preamp (reproducing circuit) RW. The composite head HEAD mounted on the suspension HAS is fixed with a carriage to make the gap with the recording medium Disk to be constant. As shown in FIG. 12, it may be configured with multiple recording head media Disks and multiple heads HEADs. The preamp (reproducing circuit) RW is mounted on the side of the carriage located nearest to the composite head HEAD in order to minimize propagation loss in the gap with the composite head HEAD. The read write circuit Channel (Read Write Channel LSI) provides a preamp (reproducing circuit) and data by fetching dimensional information for alignment of the composite head HEAD including code modulation of the write-in data and code demodulation of the read-out signals. The micro computer CPU (Central Processing Unit) controls the entire magnetic disk apparatus by controlling alignment of the composite head HEAD based on the dimensional information of the composite head HEAD that is output by the read write channel circuit Channel. The motor driver MD (Motor Driver LSI) controls the spindle motor SPM (Spindle Motor) according to the instructions from the micro computer CPU to adjust the rotation speed of the recording media Disk and the voice coil motor (VCM (Voice Coil Motor) is controlled to perform alignment adjustment of the composite head HEAD as well as supplying power by installing power supply regulator. The hard disk controller HDC (Hard Disk Controller LSI) has a DRAM (Dynamic Random Access Memory) for data buffer to take an interface between the host such as PC and the read write channel circuit Channel.

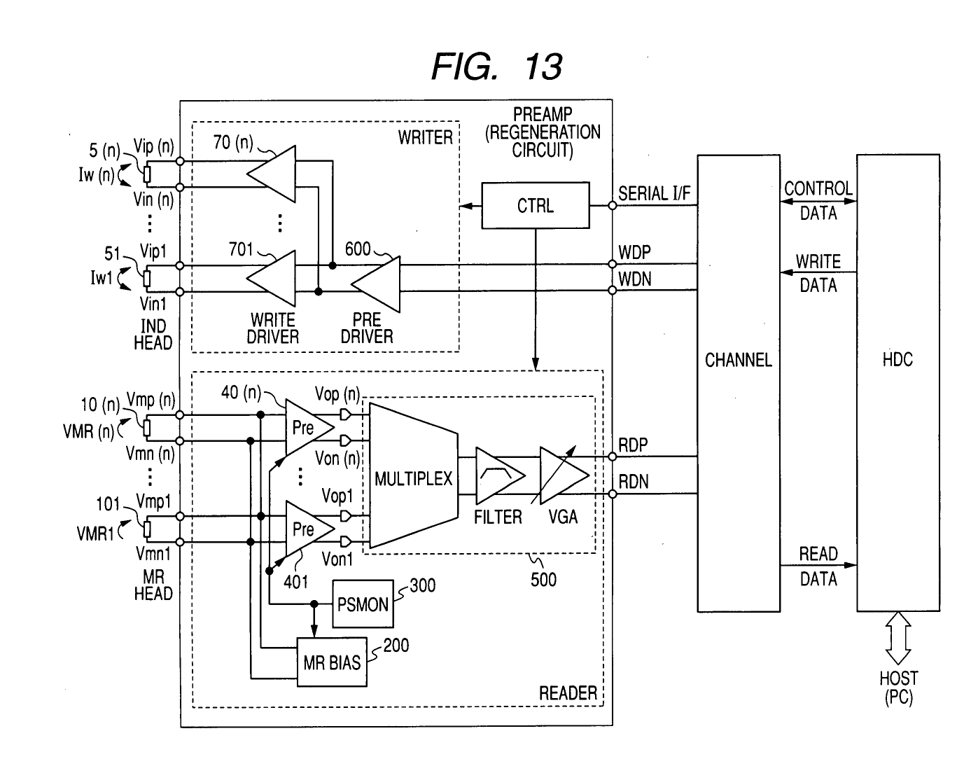

FIG. 13 shows an embodiment of the preamp wherein this invention equipped in FIG. 11 is applied and a block diagram corresponding to multiple number of heads n as explained in FIG. 12. The preamp is composed of a reproducing circuit Reader that outputs the read-out signals via the MR head 10 (n) o the read write channel Channel b amplifying, a recording circuit Writer that switches the current Iw (n) running through the magnetic head 5 (n) according to the write-in signals from the read write channel Channel, and a control circuit CTRL that controls the preamp according to the control signals from the read write channel Channel. The reproducing circuit Reader amplifies the read-out signals using an initial stage amplifier 40; (n) having multiple MR heads 10 (n) as respective inputs, a MR bias circuit 200 providing the specified value of bias voltage of the selected MR heads, a Multiplex receiving the outputs from each initial stage amplifier that constitutes the latter stage amplifier 500, a Filter for forming waveforms of the amplified signals from the heads selected by Multiplex, and VGA (Variable Gain Amplifier) for adjusting the amplification rate. The power supply voltage monitor circuit 300 controls the MR bias circuit 200 and the initial-stage amplifier 40 (n) depending upon the power supply voltage, in order to prevent the occurrence of overvoltage of the MR head bias voltage VMR(n). The recording circuit Writer is composed of a pre-driver 600 for buffering the write-in signals and a write driver 70 (n) which switches the current Iw (n) running through the magnetic head 5 (n) in accordance with the write-in signals, and writes the data in a recording medium by driving the magnetic head 5 (n). The control circuit CTRL controls the values of MR head bias voltage VMR (n) and the write in current Iw (n), and the amplification rate as well as switching the operation modes such as sleep/read/write according to the control signals from the read write channel Channel.

As for the effect of the preamp wherein this invention is applied, since a reproducing circuit is installed which is characterized in that the MR head bias voltage VMR (n) does not exceed the specified value and controls the central voltage of the MR head to the ground during the abnormal changes in the power supply voltage including ON/OFF of the power supply, it is protected from the MR head damage attributed to the overvoltage of the MR bias voltage VMR (n) due to power supply voltage malfunctions and changes from the grounding of the MR head central voltage. That is, it is possible to prevent failure of the magnetic disk apparatus. Also, since the power supply voltage malfunction is monitored in the preamp in order to automatically control blocking and restoring of the MR head bias voltage VMR (n), extra processing is not required for the read write channel Channel and hard disk controller HDC. For example, in the preamp wherein this invention is not applied, it is possible to prevent the occurrence of overvoltage in the MR head bias voltage by shifting the preamp during the power supply voltage malfunction to a sleep mode. However, once it is shifted to a sleep mode, the preamp cannot returned to an active state without controls by the read write channel Chennel and had disk controller HDC. Thus, as an effect of this invention, it is possible to achieve faster recovery operation of the magnetic disk apparatus when being restored from the power supply voltage malfunction.

This invention was explained above by the inventors specifically based on the embodiments of this invention. However, this invention will not be limited to the embodiments and it can be modified diversely in the scope not excluded from the objective of this invention.

What is claimed is:

1. A reproducing circuit, which is configured to be connected to a magnetoresistive head and read write channel circuits, the reproducing circuit comprising:
a bias circuit that provides bias voltage specified relative to the magnetoresistive head;
an amplifying circuit for amplifying the output signals of the magnetoresistive head;
a power supply voltage monitor circuit that monitors the changes in the power supply voltage; and
a control circuit that is controlled by the power supply voltage monitor circuit,
wherein the bias voltage does not exceed the specified value during the malfunctions of the power supply voltage including the cases of power supply ON/OFF, and the central voltage of the magnetoresistive head is controlled to the ground.

2. The reproducing circuit according to claim 1,
wherein the bias circuit or the amplifying circuit are controlled by the control circuit, and the bias voltage does not exceed the specified value during the malfunctions of the power supply voltage including the cases of power supply ON/OFF, and the central voltage of the magnetoresistive head is controlled to the ground.

3. The reproducing circuit according to claim 2,
wherein the bias circuit provides the bias voltage by a return circuit, and the control circuit controls the return circuit such that the bias voltage does not exceed the specified value during the malfunctions of the power supply voltage including the cases of power supply ON/OFF, and the central voltage of the magnetoresistive head becomes the ground.

4. The reproducing circuit according to claim 1,
wherein if the power supply voltage decreases below the specified voltage, the bias circuit transitions to the dummy head resistance to block the bias voltage.

5. The reproducing circuit according to claim 1,
wherein if the power supply voltage decreases below the specified voltage, the control circuit blocks the bias voltage.

6. The reproducing circuit according to claim 5,
wherein the control circuit is an emitter follower or a source follower using the power supply voltage dependent current generated from the power supply voltage monitor circuit, and an analog switch configuration is provided such that the output voltage can be controlled by having a resistance between the output and an arbitrary voltage.

7. The reproducing circuit according to claim 1,
wherein the power supply voltage monitor circuit monitors the power supply voltage using a dummy circuit that is initiated from the power supply voltage dependent circuit requiring operations depending upon power supply voltage.

8. The reproducing circuit according to claim 7,
wherein the dummy circuit configuring the power supply voltage monitor circuit is configured to adjust the degree of dependency on the power supply voltage by a serial connection of resistors or diodes.

9. A magnetic disk apparatus comprising:
a magnetoresistive head;
a reproducing circuit that is electrically connected to the magnetoresistive head; and
a read write channel circuit that is electrically connected to the reproducing circuit,
wherein the reproducing circuit includes:
a bias circuit that provides bias voltage specified relative to the magnetoresistive head;
an amplifying circuit for amplifying the output signals of the magnetoresistive head;
a power supply voltage monitor circuit that monitors the changes in the power supply voltage; and
a control circuit that is controlled by the power supply voltage monitor circuit, and
wherein the bias voltage does not exceed the specified value during any malfunction of the power supply voltage including the cases of power supply ON/OFF, and the central voltage of the magnetoresistive head is controlled to the ground.

10. The magnetic disk apparatus according to claim 9,
wherein the bias circuit or the amplifying circuit are controlled by the control circuit, and the bias voltage does not exceed the specified value during the malfunctions of the power supply voltage including the cases of power supply ON/OFF, and the central voltage of the magnetoresistive head is controlled to the ground.

11. The magnetic disk apparatus according to claim 10,
wherein the bias circuit provides the bias voltage by a return circuit, and the control circuit controls the return circuit such that the bias voltage does not exceed the specified value during the malfunctions of the power supply voltage including the cases of power supply ON/OFF, and the central voltage of the magnetoresistive head becomes the ground.

12. The magnetic disk apparatus according to claim 9,
wherein if the power supply voltage decreases below the specified voltage, the bias circuit transitions to the dummy head resistance to block the bias voltage.

13. The magnetic disk apparatus according to claim 9,
wherein if the power supply voltage decreases below the specified voltage, the control circuit blocks the bias voltage.

14. The magnetic disk apparatus according to claim 13,
wherein the control circuit is an emitter follower or a source follower using the power supply voltage dependent current generated from the power supply voltage monitor circuit, and an analog switch configuration is provided such that the output voltage can be controlled by having a resistance between the output and an arbitrary voltage.

15. The magnetic disk apparatus according to claim 9,
wherein the power supply voltage monitor circuit monitors the power supply voltage using a dummy circuit that is initiated from the power supply voltage dependent circuit requiring operations depending upon the power supply voltage.

16. The magnetic disk apparatus according to claim 15,
wherein the dummy circuit configuring the power supply voltage monitor circuit is configured to adjust the degree of dependency on the power supply voltage by a serial connection of resistors or diodes.
